(19) United States
(12) Patent Application Publication
(10) Pub. No.: US 2019/0044872 A1
(43) Pub. Date: Feb. 7, 2019

(54) TECHNOLOGIES FOR TARGETED FLOW CONTROL RECOVERY

(71) Applicant: Intel Corporation, Santa Clara, CA (US)

(72) Inventors: Ravindra Babu Ganapathi, Hillsboro, OR (US); Andrew Friedley, Livermore, CA (US); Jim M. Snow, Portland, OR (US); Keith D. Underwood, Powell, TX (US)

(21) Appl. No.: 15/941,490

(22) Filed: Mar. 30, 2018

(51) Int. Cl. H04L 12/823; H04L 12/801; H04L 12/835

(52) U.S. Cl. CPC H04L 47/32; H04L 47/29; H04L 47/30; H04L 47/34

(57) ABSTRACT

Technologies for targeted flow control recovery include a target computing device which detects whether resources of the target computing device are sufficient to process received messages from at least one source computing device and, in response to a determination that the resources are insufficient, (i) drops received message(s) from the affected source computing device(s) and (ii) determines whether to issue a targeted flow control recovery (i.e., at one of the source computing devices) or a global targeted flow control recovery (i.e., at all of the source computing devices) to instruct the source computing device(s) to stop transmitting messages to the target computing device. The target computing device, upon completion of the flow control recovery, atomically enables a table entry for which resources to process the received message(s) have been allocated and transmits a targeted or global resume transmission message to the source computing device(s) to instruct the source computing device to resume transmitting messages to the target computing device.

### BACKGROUND

Modern computing devices have become ubiquitous tools for personal, business, and social uses. As such, many modern computing devices are capable of connecting to various data networks, including the Internet, to transmit and receive data communications over the various data networks at varying rates of speed. To facilitate communications between computing devices, the data networks typically include one or more network computing devices (e.g., compute servers, storage servers, etc.) to route communications (e.g., via switches, routers, etc.) that enter/exit a network (e.g., north-south network traffic) and between network computing devices in the network (e.g., east-west network traffic). In present packet-switched network architectures, data is transmitted in the form of network packets between networked computing devices. At a high level, data is packetized into a network packet at a source computing device, which is then sent to a transmission component (e.g., a network interface controller (NIC) of the respective source computing device) responsible for dispatching the network packet to a target computing device over a network.

Applications (e.g., message passing interface (MPI) applications) can send and receive network packets in various patterns and, in some cases, network packets can be received from several source computing devices at a single target computing device at a high message rate, which can exhaust the resources of the target computing device causing overflow. To address such issues, various flow control techniques have been implemented. However, certain applications have requirements that messages from a single source computing device be received, or matched, at the target computing device in the order in which they were sent by the source computing device.

Flow control techniques used in such conditions are usually expected to prevent messages from being delivered out-of-order due to dropped packets or other reasons. This is usually accomplished by dropping all packets that did not arrive in order and requiring dropped packets to be re-sent in the original order. In other words, upon the retransmission of network packets, all network packets including and after any dropped network packets must be resent in the original order. Further, existing flow control techniques are typically connection-oriented (i.e., a lot of per-connection states), which could include credits, congestion windows, state machines, etc., which tend to not scale well in applications where each host may be communicating with a very large number of peers.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for targeted flow control recovery that includes a target computing device communicatively coupled to multiple source computing devices;

FIG. 2 is a simplified block diagram of at least one embodiment of a computing device of the system of FIG. 1;

FIG. 3 is a simplified block diagram of at least one embodiment of an environment of one of the source computing devices of the system of FIG. 1;

FIG. 4 is a simplified block diagram of at least one embodiment of an environment of the target computing device of the system of FIG. 1;

FIG. 5 is a simplified flow diagram of at least one embodiment of a method for handling a received flow control indication that may be executed by the source computing device of FIG. 3; and

FIGS. 6A-6C are a simplified block diagram of at least one embodiment of a method for targeted flow control recovery that may be executed by the target computing device of FIG. 4.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C): (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

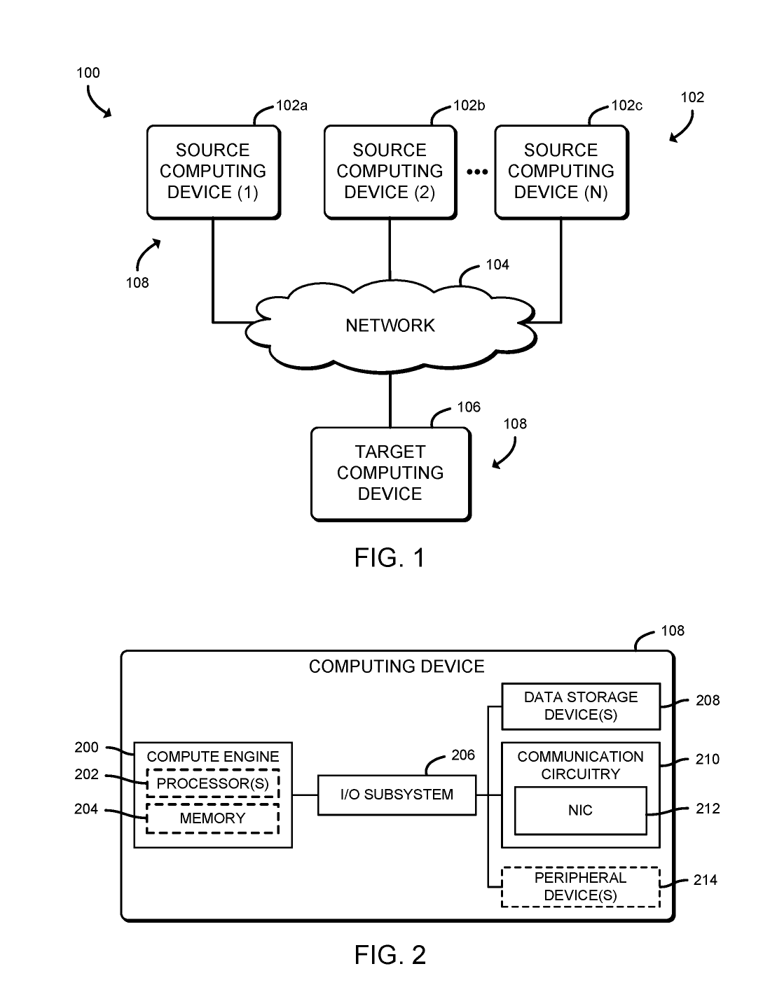

Referring now to FIG. 1, in an illustrative embodiment, a system 100 for targeted flow control recovery includes multiple source computing devices 102 communicatively coupled to a target computing device 106 via a network 104. In use, the target computing device 106 receives and processes messages (e.g., network packets, Ethernet frames, etc.) received from the source computing devices 102 (i.e., a one-to-many relationship). As illustratively shown, the system 100 includes a first source computing device 102, designated as source computing device (1) 102a, a second source computing device 102, designated as source computing device (2) 102b, and a third source computing device 102, designated as source computing device (N) 102c (e.g., in which the source computing device (N) 102c represents the “Nth” source computing device 102 and wherein “N” is a positive integer).

Under certain conditions, such as resource exhaustion, the target computing device 106 may implement a flow control process to stop messages (i.e., data transmissions) from being sent by the affected source computing devices 102 until the condition can be detected and resolved. Otherwise, data overflow can occur and the received data can be lost (e.g., due to dropping the received message) and require retransmission. To do so, the target computing device 106 is configured to target flow control recovery to only those impacted flow(s) by localizing the flow control to source computing devices 102 whose received messages have been dropped by the target computing device 106 due to resource exhaustion. Accordingly, unlike existing flow control techniques which employ global flow control recovery techniques, the target computing device 106 can reduce congestion without impacting those source computing devices 102 that are not affected by lost/dropped messages.

The source computing device 102 may be embodied as any type of computation or computer device capable of performing the functions described herein, including, without limitation, a portable computing device (e.g., smartphone, tablet, laptop, notebook, wearable, etc.) that includes mobile hardware (e.g., processor, memory, storage, wireless communication circuitry, etc.) and software (e.g., an operating system) to support a mobile architecture and portability, a computer, a server (e.g., stand-alone, rack-mounted, blade, etc.), a network appliance (e.g., physical or virtual), a web appliance, a distributed computing system, a processor-based system, and/or a multiprocessor system. The target computing device 106 may be embodied as any type of computation or computer device capable of performing the functions described herein, including, without limitation, a server (e.g., stand-alone, rack-mounted, blade, sled, etc.): switch (e.g., a disaggregated switch, a rack-mounted switch, a standalone switch, a fully managed switch, a partially managed switch, a full-duplex switch, and/or a half-duplex communication mode enabled switch), a router, a network appliance (e.g., physical or virtual), a web appliance, a distributed computing system, a processor-based system, and/or a multiprocessor system.

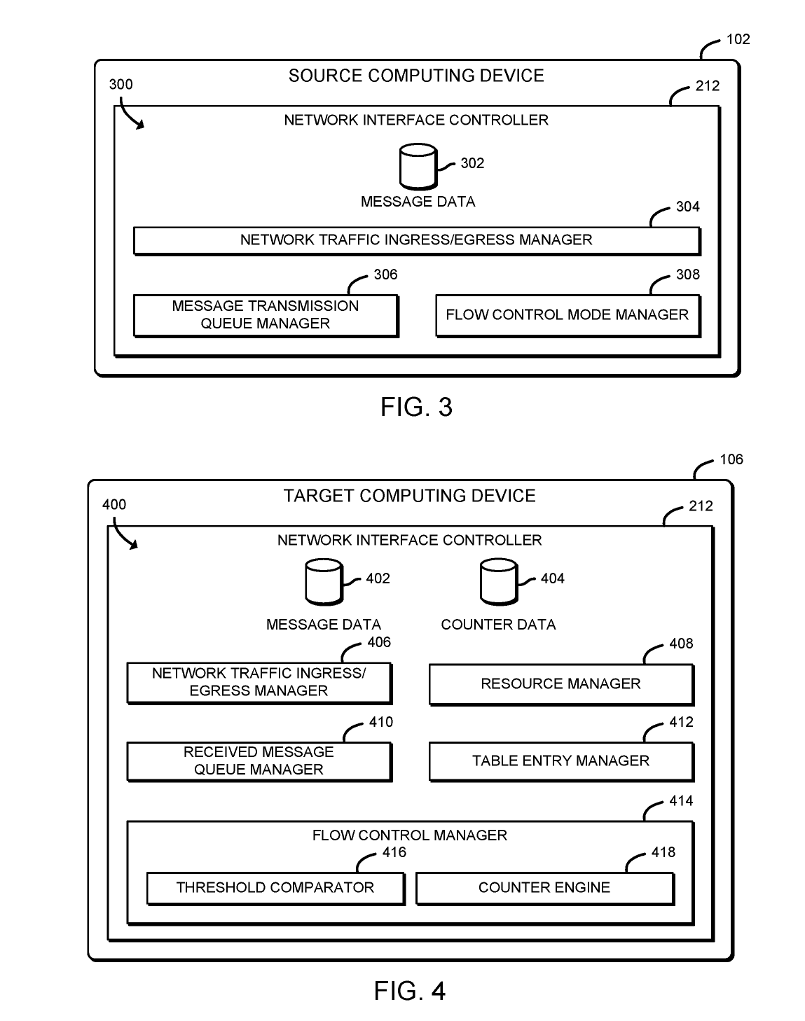

Referring now to FIG. 2, an illustrative computing device 108 (e.g., one of the source computing devices 102 or the target computing device 106) includes a compute engine 200, an I/O subsystem 206, one or more data storage devices 208, communication circuitry 210, and, in some embodiments, one or more peripheral devices 212. It should be appreciated that the computing device 108 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component.

The compute engine 200 may be embodied as any type of device or collection of devices capable of performing the various compute functions as described herein. In some embodiments, the compute engine 200 may be embodied as a single device such as an integrated circuit, an embedded system, a field-programmable-array (FPGA), a system-on-a-chip (SOC), an application specific integrated circuit (ASIC), reconfigurable hardware or hardware circuitry, or other specialized hardware to facilitate performance of the functions described herein. Additionally, in some embodiments, the compute engine 200 may include, or may be embodied as, one or more processors 202 (i.e., one or more central processing units (CPUs)) and memory 204.

The processor(s) 202 may be embodied as any type of processor capable of performing the functions described herein. For example, the processor(s) 202 may be embodied as one or more single-core processors, one or more multi-core processors, a digital signal processor, a microcontroller, or other processor or processing/controlling circuit(s). In some embodiments, the processor(s) 202 may be embodied as, include, or otherwise be coupled to a field programmable gate array (FPGA), an application specific integrated circuit (ASIC), reconfigurable hardware or hardware circuitry, or other specialized hardware to facilitate performance of the functions described herein.

The memory 204 may be embodied as any type of volatile (e.g., dynamic random access memory (DRAM), etc.) or non-volatile memory or data storage capable of performing the functions described herein. It should be appreciated that the memory 204 may include main memory (i.e., a primary memory) and/or cache memory (i.e., memory that can be accessed more quickly than the main memory). Volatile memory may be a storage medium that requires power to maintain the state of data stored by the medium. Non-limiting examples of volatile memory may include various types of random access memory (RAM), such as dynamic random access memory (DRAM) or static random access memory (SRAM).

The compute engine 200 is communicatively coupled to other components of the computing device 108 via the I/O subsystem 206, which may be embodied as circuitry and/or components to facilitate input/output operations with the processor 202, the memory 204, and other components of the computing device 108. For example, the I/O subsystem 206 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 206 may form a portion of a system-on-a-chip (SoC) and be incorporated, along with one or more of the processor 202, the memory 204, and other components of the computing device 108, on a single integrated circuit chip.

The one or more data storage devices 208 may be embodied as any type of storage device(s) configured for short-term or long-term storage of data, such as, for example, memory devices and circuits, memory cards, hard disk drives, solid-state drives, or other data storage devices. Each data storage device 208 may include a system partition that stores data and firmware code for the data storage device 208. Each data storage device 208 may also include an operating system partition that stores data files and executables for an operating system.

The communication circuitry 210 may be embodied as any communication circuit, device, or collection thereof, capable of enabling communications between the computing device 108 and other computing devices, as well as any network communication enabling devices, such as an access point, network switch/router, etc., to allow communication over the network 104. Accordingly, the communication circuitry 210 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication.

It should be appreciated that, in some embodiments, the communication circuitry 210 may include specialized circuitry, hardware, or combination thereof to perform pipeline logic (e.g., hardware algorithms) for performing the functions described herein, including processing network packets (e.g., parse received network packets, determine destination computing devices for each received network packets, forward the network packets to a particular buffer queue of a respective host buffer of the computing device 108, etc.), performing computational functions, etc.

In some embodiments, performance of one or more of the functions of communication circuitry 210 as described herein may be performed by specialized circuitry, hardware, or combination thereof of the communication circuitry 210, which may be embodied as a system-on-a-chip (SoC) or otherwise form a portion of a SoC of the computing device 108 (e.g., incorporated on a single integrated circuit chip along with a processor 202, the memory 204, and/or other components of the computing device 108). Alternatively, in some embodiments, the specialized circuitry, hardware, or combination thereof may be embodied as one or more discrete processing units of the computing device 108, each of which may be capable of performing one or more of the functions described herein.

The illustrative communication circuitry 210 includes a network interface controller (NIC) 212, also commonly referred to as a host fabric interface (HFI) in some embodiments (e.g., high-performance computing (HPC) environments). The NIC 212 may be embodied as one or more add-in-boards, daughtercards, network interface cards, controller chips, chipsets, or other devices that may be used by the computing device 108. In some embodiments, the NIC 212 may be embodied as part of a system-on-a-chip (SoC) that includes one or more processors, or included on a multichip package that also contains one or more processors. In some embodiments, the NIC 212 may include a local processor (not shown) and/or a local memory (not shown) that are both local to the NIC 212. In such embodiments, the local processor of the MC 212 may be capable of performing one or more of the functions of a processor 202 described herein.

Additionally or alternatively, in such embodiments, the local memory of the NIC 212 may be integrated into one or more components of the computing device 108 at the board level, socket level, chip level, and/or other levels. For example, in some embodiments, the NIC 212 may be integrated with the processor 202, embodied as an expansion card coupled to the I/O subsystem 204 over an expansion bus (e.g., PCI Express), part of a SoC that includes one or more processors, or included on a multichip package that also contains one or more processors. Additionally or alternatively, in some embodiments, functionality of the NIC 212 may be integrated into one or more components of the computing device 108 at the board level, socket level, chip level, and/or other levels.

Referring back to FIG. 1, the network 104 may be embodied as any type of wired or wireless communication network, including but not limited to a wireless local area network (WLAN), a wireless personal area network (WPAN), a cellular network (e.g., Global System for Mobile Communications (GSM), Long-Term Evolution (LTE), etc.), a telephony network, a digital subscriber line (DSL) network, a cable network, a local area network (LAN), a wide area network (WAN), a global network (e.g., the Internet), or any combination thereof. It should be appreciated that, in such embodiments, the network 104 may serve as a centralized network and, in some embodiments, may be communicatively coupled to another network (e.g., the Internet). Accordingly, the network 104 may include a variety of other virtual and/or physical network computing devices (e.g., routers, switches, network hubs, servers, storage devices, compute devices, (high-speed) interconnects, etc.), as needed to facilitate communication between the source computing devices 102 and the target computing device 106, which are not shown to preserve clarity of the description.

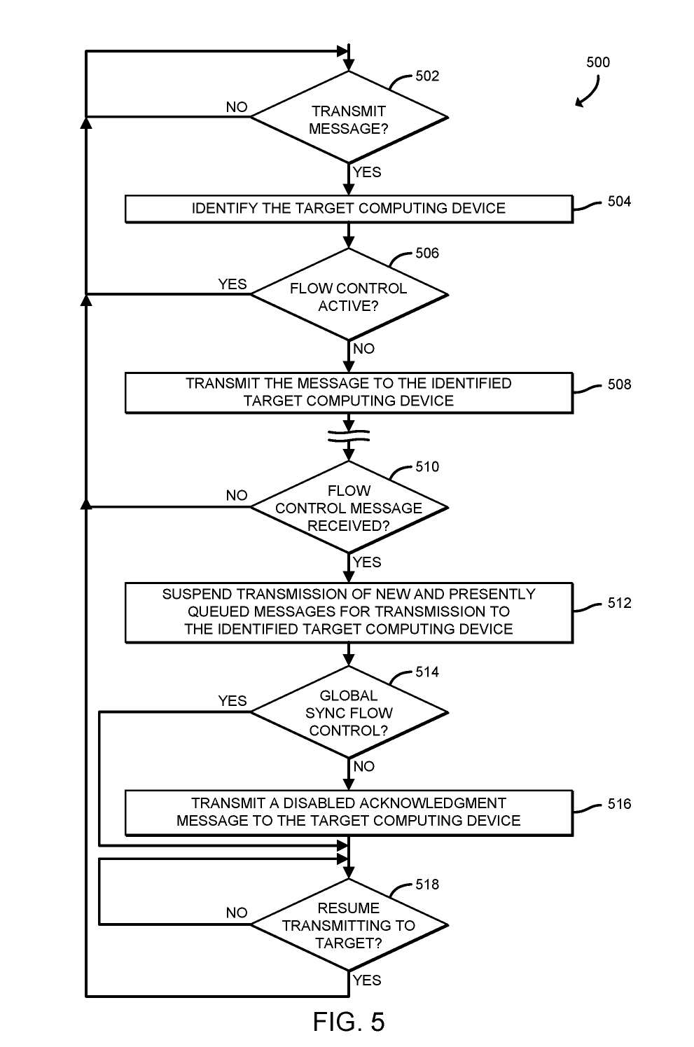

Referring now to FIG. 3, in use, the source computing device 102 (i.e., one of the source computing devices 102 of FIG. 1) establishes an environment 300 during operation. The illustrative environment 300 includes a network traffic ingress/egress manager 304, a message transmission queue manager 306, and a flow control mode manager 308. The various components of the environment 300 may be embodied as hardware, firmware, software, or a combination thereof. As such, in some embodiments, one or more of the components of the environment 300 may be embodied as circuitry or collection of electrical devices (e.g., network traffic ingress/egress management circuitry 304, message transmission queue management circuitry 306, flow control mode management circuitry 308, etc.).

It should be appreciated that, in such embodiments, one or more of the network traffic ingress/egress management circuitry 304, the message transmission queue management circuitry 306, and the flow control mode management circuitry 308 may form a portion of one or more of the compute engine 200, the I/O subsystem 206, the communication circuitry 210 (e.g., the NIC 212 of the communication circuitry 210, as illustratively shown), and/or other components of the source computing device 102. Additionally, in some embodiments, one or more of the illustrative components may form a portion of another component and/or one or more of the illustrative components may be independent of one another. Further, in some embodiments, one or more of the components of the environment 300 may be embodied as virtualized hardware components or emulated architecture, which may be established and maintained by the compute engine 200 or other components of the source computing device 102. It should be appreciated that the source computing device 102 may include other components, sub-components, modules, sub-modules, logic, sub-logic, and/or devices commonly found in a computing device, which are not illustrated in FIG. 3 for clarity of the description.

In the illustrative environment 300, the source computing device 102 additionally includes message data 302, which may be accessed by the various components and/or sub-components of the source computing device 102. Additionally, it should be appreciated that in some embodiments at least a portion of the data stored in, or otherwise represented by, the message data 302 may be stored in additional or alternative storage locations (e.g., host memory of the source computing device 102). As such, although the various data utilized by the source computing device 102 is described herein as particular discrete data, such data may be combined, aggregated, and/or otherwise form portions of a single or multiple data sets, including duplicative copies, in other embodiments.

The network traffic ingress/egress manager 304, which may be embodied as hardware, firmware, software, virtualized hardware, emulated architecture, and/or a combination thereof as discussed above, is configured to receive inbound and route/transmit outbound network traffic. To do so, the network traffic ingress/egress manager 304 is configured to facilitate inbound/outbound network communications (e.g., network traffic, network packets, network flows, etc.) to and from the source computing device 102. For example, the network traffic ingress/egress manager 304 is configured to manage (e.g., create, modify, delete, etc.) connections to physical and virtual network ports (i.e., virtual network interfaces) of the source computing device 102 (e.g., via the communication circuitry 210), as well as the ingress/egress buffers/queues associated therewith. In some embodiments, information associated with the header(s) and/or the payload of the network communications (e.g., messages, data, etc.) may be stored in the message data 302.

The message transmission queue manager 306, which may be embodied as hardware, firmware, software, virtualized hardware, emulated architecture, and/or a combination thereof as discussed above, is configured to manage the queue of messages to be transmitted (e.g., to the target computing device 106). To do so, the message transmission queue manager 306 is configured to identify which egress buffer is associated with the applicable target computing device 106. The message transmission queue manager 306 is additionally configured to track whether transmitted messages have been successfully received by the target computing device 106 (e.g., based on a received acknowledgment message, a timeout, etc.). It should be appreciated that, in some embodiments, at least a portion of one or more of the functions described herein as being performed by the message transmission queue manager 306 may be performed by the network traffic ingress/egress manager 304, or vice versa.

The flow control mode manager 308, which may be embodied as hardware, firmware, software, virtualized hardware, emulated architecture, and/or a combination thereof as discussed above, is configured to manage a flow control mode of the source computing device 102. For example, under certain conditions, during normal message transmission operation, the flow control mode manager 308 may receive an indication (e.g., a flow control message) that indicates the resources of the target computing device 106 which have been allocated to the source computing devices 102 have been exhausted. In other words, the target computing device 106 has indicated that one or messages were dropped by the target computing device 106 as a result of the target computing device 106 having insufficient resources to successfully process one or more messages transmitted by the source computing device 102.

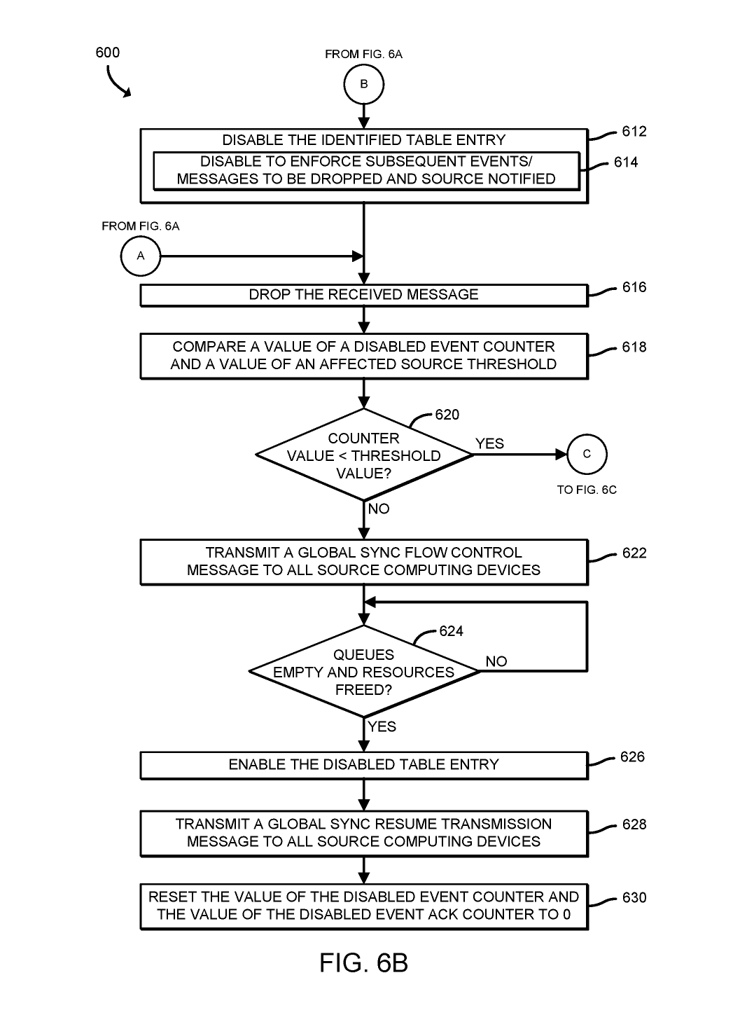

Additionally, the flow control mode manager 308 is configured to suspend transmission of additional messages (e.g., such as those messages queued by the message transmission queue manager 306 which are ready for transmission) to the affected target computing device 106. The flow control mode manager 308 is further configured to determine whether the flow control message received from the affected target computing device 106 has indicated the flow control operation was a targeted flow control or a global sync flow control. Depending on the type of flow control operation, the flow control mode manager 308 may be configured to transmit an acknowledgement of the received flow control message (see, e.g., the method 500 of FIG. 5). The flow control mode manager 308 is additionally configured to resume transmission of the queue messages upon having received an indication that the flow control has been resolved.

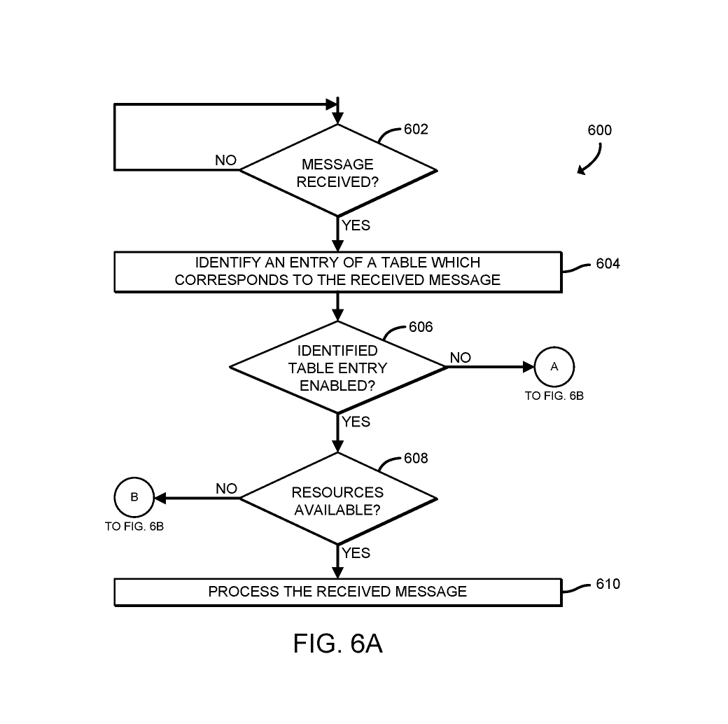

Referring now to FIG. 4, in use, the target computing device 106 establishes an environment 400 during operation. The illustrative environment 400 includes a network traffic ingress/egress manager 406, a resource manager 408, a received message queue manager 410, a table entry manager 412, and a flow control manager 414. The various components of the environment 300 may be embodied as hardware, firmware, software, or a combination thereof. As such, in some embodiments, one or more of the components of the environment 400 may be embodied as circuitry or collection of electrical devices (e.g., network traffic ingress/egress management circuitry 406, resource management circuitry 408, received message queue management circuitry 410, table entry management circuitry 412, flow control management circuitry 414, etc.).

It should be appreciated that, in such embodiments, one or more of the network traffic ingress/egress management circuitry 406, the resource management circuitry 408, the received message queue management circuitry 410, the table entry management circuitry 412, and the flow control management circuitry 414 may form a portion of one or more of the compute engine 200, the I/O subsystem 206, the communication circuitry 210 (e.g., the NIC 212 of the communication circuitry 210, as illustratively shown), and/or other components of the target computing device 106. Additionally, in some embodiments, one or more of the illustrative components may form a portion of another component and/or one or more of the illustrative components may be independent of one another. Further, in some embodiments, one or more of the components of the environment 400 may be embodied as virtualized hardware components or emulated architecture, which may be established and maintained by the compute engine 200 or other components of the target computing device 106. It should be appreciated that the target computing device 106 may include other components, sub-components, modules, sub-modules, logic, sub-logic, and/or devices commonly found in a computing device, which are not illustrated in FIG. 4 for clarity of the description.

In the illustrative environment 400, the target computing device 106 additionally includes message data 402 and counter data 404, each of which may be accessed by the various components and/or sub-components of the target computing device 106. Additionally, it should be appreciated that in some embodiments at least a portion of the data stored in, or otherwise represented by, the message data 402 and/or the counter data 404 may be stored in additional or alternative storage locations (e.g., host memory of the target computing device 106). It should be further appreciated that in some embodiments the data stored in, or otherwise represented by, each of the message data 402 and the counter data 404 may not be mutually exclusive relative to each other. For example, in some implementations, data stored in the message data 402 may also be stored as a portion of the counter data 404. As such, although the various data utilized by the target computing device 106 is described herein as particular discrete data, such data may be combined, aggregated, and/or otherwise form portions of a single or multiple data sets, including duplicative copies, in other embodiments.

The network traffic ingress/egress manager 406, which may be embodied as hardware, firmware, software, virtualized hardware, emulated architecture, and/or a combination thereof as discussed above, is configured to receive inbound and route/transmit outbound network traffic. To do so, the network traffic ingress/egress manager 406 is configured to facilitate inbound/outbound network communications (e.g., network traffic, network packets, network flows, etc.) to and from the target computing device 106. For example, the network traffic ingress/egress manager 406 is configured to manage (e.g., create, modify, delete, etc.) connections to physical and virtual network ports (i.e., virtual network interfaces) of the target computing device 106 (e.g., via the communication circuitry 210), as well as the ingress/egress buffers/queues associated therewith. In some embodiments, information associated with the header(s) and/or the payload of the received network communications (e.g., messages, data, etc.) may be stored in the message data 402.

The resource manager 408, which may be embodied as hardware, firmware, software, virtualized hardware, emulated architecture, and/or a combination thereof as discussed above, is configured to manage the allocation and utilization of resources (e.g., compute, storage, etc.) of the target computing device 106. To do so, the resource manager 408 is configured to track telemetry and utilization data of the resources over time. As such, the resource manager 408 can appropriately allocate resources for a particular flow (e.g., associated with a particular source computing device 102), a flow type, etc. Additionally, the resource manager 408 may be configured to determine whether sufficient resources are available to allocate to process a received message (e.g., determine whether the packet should be dropped or processed based on whether sufficient resources are available).

The received message queue manager 410, which may be embodied as hardware, firmware, software, virtualized hardware, emulated architecture, and/or a combination thereof as discussed above, is configured to manage the queues of messages received from the various source computing devices 102. For example, the queues may hold received messages which are to be processed by the target computing device 106. Accordingly, the received message queue manager 410 may be configured to determine whether to process or drop the message, such as may be determined based on whether sufficient resources are available to process the message (e.g., as may be determined by the resource manager 408). It should be appreciated that, in some embodiments, at least a portion of one or more of the functions described herein as being performed by the received message queue manager 410 may be performed by the network traffic ingress/egress manager 406, or vice versa.

The table entry manager 412, which may be embodied as hardware, firmware, software, virtualized hardware, emulated architecture, and/or a combination thereof as discussed above, is configured to manage one or more tables, each of which includes multiple table entries, which are managed by the table entry manager 412. In an illustrative embodiment, each of the table entries includes one or more data structures (e.g., lists) which can be used to map resources to entries of the data structure. In other words, the table entry manager 412 is configured to identify, update, enable, and disable table entries of the tables (e.g., via a corresponding index). In an illustrative example using Portals (e.g., Portals 4), the table entry manager 412 may identify, update, enable, and disable a Portal Table Entry (PTE) or a Portals Table (e.g., matching or non-matching) which has several data structures attached, including a priority list, an overflow list, an unexpected list, and, optionally, an event queue.

It should be appreciated that the each table entry (e.g., matching or non-matching entry in Portals) may include information usable to identify a memory region previously allocated and associated (e.g., assigned to) each table entry, as well as an optional counting event. It should be further appreciated that such memory regions typically specify the memory to be used in the processing of at least a portion of a received message. Additionally, the counting event may optionally be used to record the occurrence of such message processing operations. In some embodiments, information about such message processing operations may be recorded in the event queue attached to the respective table entry. The table entry manager 412 is further configured to enable/disable table entries atomically. The table entry manager 412 is additionally configured to return an identifier of the determined table entry associated with a received message to a requesting entity (e.g., if the message has been dropped).

The flow control manager 414, which may be embodied as hardware, firmware, software, virtualized hardware, emulated architecture, and/or a combination thereof as discussed above, is configured to determine whether to initiate flow control mechanisms of the target computing device 106. Accordingly, the flow control manager 414 is configured to determine whether a condition exists (e.g., resource exhaustion) for one or more source computing devices 102 such that flow control measures are to be taken. In response to a determination that such a condition exists, the flow control manager 414 is configured to determine whether to initiate a targeted flow control recovery or a global sync flow control recovery.

To do so, the flow control manager 414 is configured to compare a disabled event counter (e.g., a NUM_PTL_DISABLED_EVENT counter) against an affected source threshold. The affected source threshold may be a predetermined value, a dynamic changing value (e.g., based on a number of source computing devices 102 presently connected to the target computing device 106, a size of a connected cluster of source computing devices 102, etc.), a mathematical function which accommodates scale, etc. If the flow control manager 414 determines that the disabled event counter is less than the affected source threshold, the flow control manager 414 is configured to initiate a targeted flow control recovery in which a source disable response message is sent to the applicable source computing device 102.

The flow control manager 414 is further configured to monitor the value of the disabled event counter until the disabled event counter is equal to the affected source threshold, at which point the flow control manager 414 is configured to provide an indication to each of the source computing devices 102 that they may resume message transmission. Additionally, the flow control manager 414 is configured increment the disabled event counter if the flow control manager 414 determines that the disabled event counter is less than the affected source threshold. Otherwise, if the disabled event counter is greater than or equal to the affected source threshold, the flow control manager 414 is configured to initiate a global sync flow control recovery, in which the flow control manager 414 is configured to transmit a global sync flow control message to each source computing device 102 communicatively coupled to the target computing device.

Referring now to FIG. 5, a method 500 for handling a received flow control indication is shown which may be executed by a source computing device (e.g., one of the source computing device 102 of FIGS. 1 and 3), or more particularly by a NIC of the source computing device (e.g., the illustrative NIC 212 of FIG. 3). The method 500 begins with block 502, in which the source computing device 102 determines whether to transmit a message to a target computing device (e.g., the target computing device 106 of FIGS. 1 and 4). If so, the method 500 advances to block 504, in which the source computing device 102 identifies the target computing device 106. In block 506, the source computing device 102 determines whether flow control recovery is presently active on the identified target computing device 106. If not, the method 400 proceeds to block 508, described below; otherwise, the method 400 returns to block 502 to determine whether to transmit the message again (i.e., the message is requeued and transmission can resume once an indication has been received from the target computing device 106 that transmission may resume).

In block 508, the source computing device 102 transmits the message to the identified target computing device 106. In block 510, the source computing device 102 determines whether a flow control message (i.e., one of a global sync resume transmission message or a targeted resume transmission message) has been received from the target computing device 106. It should be appreciated that the method 500 may iterate the previous blocks as necessary while waiting to receive a flow control message, or an acknowledgement, to determine whether a flow control message has been received from the target computing device 106. If the source computing device 102 determines that a flow control message has not been received from the target computing device 106 (e.g., due to receiving a response acknowledgement, a predetermined timeout has elapsed, etc.), the method 500 returns to block 502 to determine whether to transmit the message again; otherwise, the method 500 advances to block 512. It should be appreciated that multiple flow control messages may be in-flight at any given time, and that under such conditions, the source computing device 102 may be configured to wait for any outstanding messages to succeed, fail, or be cancelled.

In block 512, the source computing device 102 suspends transmission of any new or presently queued messages for transmission to the identified target computing device 106. In block 514, the source computing device 102 determines whether the flow control message received in block 510 is indicative of a global sync flow control (i.e., the received flow control message was a global sync flow control message). If not, the method 500 advances to block 516, in which the source computing device 102 transmits a disabled acknowledgement message to the target computing device 106. Otherwise, the method 500 jumps to block 518, in which the source computing device 102 determines whether to resume transmitting messages to the target computing device 106. In other words, the source computing device 102 determines whether a global sync resume transmission message or a targeted resume transmission message, depending on the flow control in effect, has been received from the target computing device 106.

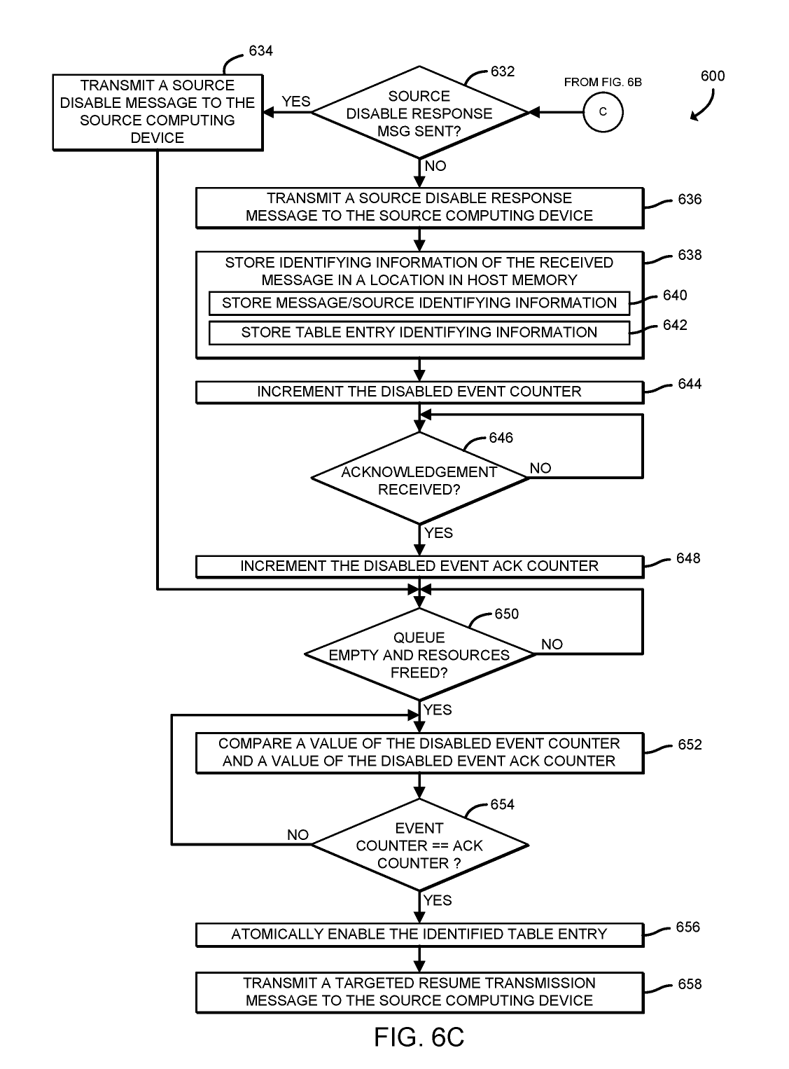

Referring now to FIGS. 6A-6C, a method 600 for targeted flow control recovery is shown which may be executed by a target computing device (e.g., the target computing device 106 of FIGS. 1 and 4), or more particularly by a NIC of the target computing device (e.g., the illustrative NIC 212 of FIG. 4). The method 600 begins in FIG. 6A with block 602, in which the target computing device 106 determines whether a message has been received from a source computing device (e.g., one of the source computing devices 102 of FIG. 1). If so, the method 600 advances to block 604, in which the target computing device 106 identifies a table entry of a table which corresponds to the received message, such as by using a set of matching bits or some other information associated with the received message. In block 606, the target computing device 106 determines whether the identified table entry is enabled. If not, the method 600 branches to block 616, shown in FIG. 6B, which is described in further detail below. Otherwise, if the target computing device 106 determines that the identified table entry is enabled, the method 600 advances to block 608.

In block 608, the target computing device 106 determines whether a sufficient amount of resources associated with (i.e., allocated to) the identified table entry are available to process the received message. If the target computing device 106 determines that sufficient resources are available, the method 600 branches to block 610, in which the target computing device 106 processes the received message (e.g., stores at least a portion of the received message in the memory of the target computing device 106, performs some computation on at least a portion of the received message, etc.). Otherwise, if the target computing device 106 determines that there are insufficient resources available, the method 600 branches to block 612.

In block 612 of FIG. 6B, the target computing device 106 disables the identified table entry before proceeding to block 616 (e.g., via triggering a PTL_NI_PT_DISABLED event in Portals). For example, in block 614, the target computing device 106 disables the identified table entry to ensure that any incoming events or messages will be dropped and a failure notification will be returned to initiating source computing device 102. It should be appreciated that, under certain conditions (e.g., during processing of a received message), resource exhaustion may be encountered. In other words, under such conditions, the target computing device 106 may atomically disable the associated table entry prior to receiving another message for processing that is associated with the table entry.

As described previously, if the target computing device 106 determines that the identified table entry is disabled in block 606, the method 600 branches to block 616. In block 616, the target computing device 106 drops the received message. In block 618, the target computing device 106 compares a value of a disabled event counter against a value of an affected source threshold. As described previously, the affected source threshold may be a predetermined value, a dynamic changing value (e.g., based on a number of source computing devices 102 presently connected to the target computing device 106, a size of a connected cluster of source computing devices 102, etc.), a mathematical function which accommodates scale, etc. In block 620, the target computing device 106 determines whether the disabled event counter is less than the affected source threshold. If so, the method 600 branches to block 632, shown in FIG. 6C, which is described in further detail below; otherwise, the method 600 branches to block 622.

In block 622, the target computing device 106 transmits a global sync flow control message to all of the source computing devices 102 communicatively coupled to the target computing device 106 and waits for notification that all source computing devices have stopped transmitting messages (these will continue to wait until the target transmits a global sync resume message). In block 624, the target computing device 106 determines whether sufficient resources have been made available (e.g., by processing some or all of the backlog of received messages) to resume accepting new messages, such as the receive queues having been emptied, or sufficiently emptied. If so, the method 600 advances to block 626, in which the target computing device 106 enables any table entries which were previously disabled as a result of the flow control recovery. In block 628, the target computing device 106 transmits a global sync resume transmission message (i.e., an indication to each of the source computing devices 102 that they may resume message transmissions to the target computing device 106) to all of the source computing devices 102. Additionally, in block 630, the target computing device 106 resets the values of the disabled event counter and the disabled event acknowledgement counter to zero.

As described previously, if the target computing device 106 determines that the disabled event counter is less than the affected source threshold in block 618, the method 600 branches to block 632 of FIG. 6C. In block 632, the target computing device 106 determines whether a source disable response message has been sent to the source computing device from which the message was received in block 602. In other words, the target computing device 106 determines whether this is the first message received from the source computing device since the target computing device 106 entered into flow control recovery, or a subsequent message. If the source disable response message has previously been sent, the method 600 branches to block 634, in which the target computing device 106 transmits a source disable message to the source computing device 102 before the method 600 proceeds to block 650, which is described below.

It should be appreciated that the source disable message is distinguished from the source disable response message in that an acknowledgment from the source computing device 102 is not requested upon receipt of the source disable message, whereas an acknowledgement from the source computing device 102 is requested upon receipt of the source disable response message. If the target computing device 106 determines, in block 632, that the source disable response message has not been previously been sent, the method 600 branches to block 636. In block 636, the target computing device 106 transmits a source disable response message to the source computing device from which the message was received in block 602. In block 638, the target computing device 106 stores identifying information of the received message in a location in host memory (e.g., the memory 204 or data storage device 208 of FIG. 2) of the target computing device 106. To do so, in block 640, the target computing device 106 stores message data and/or source identifier information of the received message. Additionally, in block 642, the target computing device 106 stores table entry identifying information usable to identify the table entry identified in block 604.

In block 644, the target computing device 106 increments the disabled event counter. In block 646, the target computing device 106 determines whether a disabled event acknowledgment has been received from the source computing device (i.e., in response to a source disable response message transmitted to the source computing device in block 634). If so, the method 600 advances to block 648, in which the target computing device 106 increments the disabled event acknowledgment counter. In block 650, the target computing device 106 determines whether the receive queues associated with the identified table entry have been emptied and whether the resources (i.e., message processing resources) associated with the identified table entry have been freed. If so, the method 500 advances to block 652, in which the target computing device 106 compares a value of the disabled event counter and a value of the disabled event acknowledgment counter.

In block 654, the target computing device 106 determines whether the value of the disabled event counter is equal to the value of the disabled event acknowledgment counter. If not, the method 600 returns to block 652 to again compare the counter values; otherwise, the method advances to block 656. It should be appreciated that the determination performed at block 646 may be executing in parallel for a number of disabled event acknowledgments from multiple source computing devices 102. Further, if new network traffic arrives destined to the disabled portal, the target computing device 106 may be configured to send additional portal-disabled messages (e.g., if the new network traffic has been received from a new source computing device 102) and increment the disabled event counter. Under such conditions, if the target computing device 106 receives a disabled event acknowledgment, the target computing device 106 is further configured to increment the disabled event acknowledgement counter and check again compare the counter values.

In some embodiments, the method 600 may proceed to blocks 650-654 while waiting for the disabled event acknowledgment to be received from the source computing device. Accordingly, it should be appreciated that the method 600 may not proceed to block 656 until conditional blocks 646, 650, and 654 have been satisfied. In block 656, the target computing device 106 enables the table entry atomically with respect to the disabled event and disabled event acknowledgement counters being equal and the receive logic determining whether the table entry is enabled or not. In block 658, the target computing device 106 transmits a targeted resume transmission message (i.e., an indication to the source computing device 102 that it may resume message transmissions to the target computing device 106) to the source computing device from which the message was received in block 602.

### EXAMPLES

Illustrative examples of the technologies disclosed herein are provided below. An embodiment of the technologies may include any one or more, and any combination of, the examples described below.

Example 1 includes a target computing device for targeted flow control recovery, the target computing device comprising a compute engine; and a network interface controller (NIC) to receive a message from a source computing device of a plurality of source computing devices communicatively coupled to the target computing device; identify, based on the received message, a table entry of a table managed by the target computing device, wherein the table entry comprises one table entry of a plurality of table entries of the table, and wherein the table entry identifies one or more resources usable to process the received message; determine whether the identified one or more resources usable to process the received message are sufficient to process the received message; drop, in response to a determination that the resources allocated to the table entry are insufficient to process the received message, the received message; disable the identified table entry; transmit a source disable response message to the source computing device, wherein the source disable response message indicates that the target computing device is in targeted flow control recovery and to instruct the source computing device to stop transmitting messages to the target computing device; increment, subsequent to the transmission of the source disable response message, a disabled event counter value; receive, in response to having transmitted the source disable response message, an acknowledgement message from the source computing device; increment, in response to having received the acknowledgement message, a disabled event acknowledgement counter value; determine whether sufficient resources of the target computing device are available to resume receiving messages; compare, in response to a determination that sufficient resources of the target computing device are available to resume receiving messages, the disabled event acknowledgement counter value and the disabled event counter value; atomically enable, in response to the determination that the disabled event counter value is equal to the disabled event acknowledgement counter value, the identified table entry; and transmit a targeted resume transmission message to the source computing device to instruct the source computing device to resume transmitting messages to the target computing device.

Example 2 includes the subject matter of Example 1, and wherein the NIC is further to determine, subsequent to having dropped the received message, whether the disabled event counter value is less than an affected source threshold value; and transmit, in response to a determination that the disabled event counter value is greater the affected source threshold value, the source disable response message to the source computing device.

Example 3 includes the subject matter of any of Examples 1 and 2, and wherein the affected source threshold comprises one of a predetermined value, a dynamic changing value, or a mathematical function which accommodates scale.

Example 4 includes the subject matter of any of Examples 1-3, and wherein the NIC is further to receive, subsequent to the identified table entry being disabled and prior to the identified table entry being atomically enabled, another message from the source computing device; drop the other received message; and transmit an indication to the source computing device that indicates the other received message has been dropped.

Example 5 includes the subject matter of any of Examples 1-4, and wherein the NIC is further to determine, subsequent to having dropped the received message, whether the disabled event counter value is greater than or equal to an affected source threshold value; and transmit, in response to a determination that the disabled event counter value is greater than or equal to the affected source threshold value, a global sync flow control message to each of the plurality of source computing devices, wherein the global sync flow control message indicates that the target computing device is in global sync flow control recovery.

Example 6 includes the subject matter of any of Examples 1-5, and wherein the NIC is further to determine whether the global sync flow control recovery has completed; atomically enable, in response to a determination that the global sync flow control recovery has completed, the disabled list table; and transmit a global sync resume transmission message to each of the plurality of source computing devices, wherein the global sync resume transmission message indicates that the global sync flow control recovery has completed.

Example 7 includes the subject matter of any of Examples 1-6, and wherein to determine whether the flow control recovery has completed comprises to determine whether each of a plurality of message receive queues have been emptied and message processing resources associated with the identified table entry have been freed.

Example 8 includes one or more machine-readable storage media comprising a plurality of instructions stored thereon that, in response to being executed, cause a target computing device to receive, by a network interface controller (NIC) of the target computing device, a message from a source computing device of a plurality of source computing devices communicatively coupled to the target computing device; identify, by the NIC and based on the received message, a table entry of a table managed by the target computing device, wherein the table entry comprises one table entry of a plurality of table entries of the table, and wherein the table entry identifies one or more resources usable to process the received message; determine, by the NIC, whether the identified one or more resources usable to process the received message are sufficient to process the received message; drop, by the NIC and in response to a determination that the resources allocated to the table entry are insufficient to process the received message, the received message; disable, by the NIC, the identified table entry; transmit, by the NIC, a source disable response message to the source computing device, wherein the source disable response message indicates that the target computing device is in targeted flow control recovery and to instruct the source computing device to stop transmitting messages to the target computing device; increment, by the NIC and subsequent to the transmission of the source disable response message, a disabled event counter value; receive, by the NIC and in response to having transmitted the source disable response message, an acknowledgement message from the source computing device; increment, by the NIC and in response to having received the acknowledgement message, a disabled event acknowledgement counter value; determine, by the NIC, whether sufficient resources of the target computing device are available to resume receiving messages; compare, by the NIC and in response to a determination that sufficient resources of the target computing device are available to resume receiving messages, the disabled event acknowledgement counter value and the disabled event counter value; atomically enable, by the NIC and in response to the determination that the disabled event counter value is equal to the disabled event acknowledgement counter value, the identified table entry; and transmit, by the NIC, a targeted resume transmission message to the source computing device to instruct the source computing device to resume transmitting messages to the target computing device.

Example 9 includes the subject matter of Example 8, and wherein the plurality of instructions further cause the NIC to determine, by the NIC and subsequent to having dropped the received message, whether the disabled event counter value is less than an affected source threshold value; and transmit, by the NIC and in response to a determination that the disabled event counter value is greater the affected source threshold value, the source disable response message to the source computing device.

Example 10 includes the subject matter of any of Examples 8 and 9, and wherein the affected source threshold comprises one of a predetermined value, a dynamic changing value, or a mathematical function which accommodates scale.

Example 11 includes the subject matter of any of Examples 8-10, and wherein the plurality of instructions further cause the NIC to receive, by the NIC and subsequent to the identified table entry being disabled and prior to the identified table entry being atomically enabled, another message from the source computing device; drop, by the NIC, the other received message; and transmit, by the NIC, an indication to the source computing device that indicates the other received message has been dropped.

Example 12 includes the subject matter of any of Examples 8-11, and wherein the plurality of instructions further cause the NIC to determine, by the NIC and subsequent to having dropped the received message, whether the disabled event counter value is greater than or equal to an affected source threshold value; and transmit, by the NIC and in response to a determination that the disabled event counter value is greater than or equal to the affected source threshold value, a global sync flow control message to each of the plurality of source computing devices, wherein the global sync flow control message indicates that the target computing device is in global sync flow control recovery..

Example 13 includes the subject matter of any of Examples 8-12, and wherein the plurality of instructions further cause the NIC to determine, by the NIC, whether the global sync flow control recovery has completed; atomically enable, by the NIC and in response to a determination that the global sync flow control recovery has completed, the disabled list table; and transmit, by the NIC, a global sync resume transmission message to each of the plurality of source computing devices, wherein the global sync resume transmission message indicates that the global sync flow control recovery has completed.

Example 14 includes the subject matter of any of Examples 8-13, and wherein to determine whether the flow control recovery has completed comprises to determine whether each of a plurality of message receive queues have been emptied and message processing resources associated with the identified table entry have been freed.

Example 15 includes a target computing device for targeted flow control recovery, the target computing device comprising circuitry for receiving a message from a source computing device of a plurality of source computing devices communicatively coupled to the target computing device; means for identifying, based on the received message, a table entry of a table managed by the target computing device, wherein the table entry comprises one table entry of a plurality of table entries of the table, and wherein the table entry identifies one or more resources usable to process the received message; means for determining whether the identified one or more resources usable to process the received message are sufficient to process the received message; circuitry for dropping, in response to a determination that the resources allocated to the table entry are insufficient to process the received message, the received message; means for disabling the identified table entry; means for transmitting a source disable response message to the source computing device, wherein the source disable response message indicates that the target computing device is in targeted flow control recovery and to instruct the source computing device to stop transmitting messages to the target computing device; means for incrementing, subsequent to the transmission of the source disable response message, a disabled event counter value; means for receiving, in response to having transmitted the source disable response message, an acknowledgement message from the source computing device; means for incrementing, in response to having received the acknowledgement message, a disabled event acknowledgement counter value; means for determining whether sufficient resources of the target computing device are available to resume receiving messages; means for comparing, in response to a determination that sufficient resources of the target computing device are available to resume receiving messages, the disabled event acknowledgement counter value and the disabled event counter value; means for atomically enabling, in response to the determination that the disabled event counter value is equal to the disabled event acknowledgement counter value, the identified table entry; and circuitry for transmitting a targeted resume transmission message to the source computing device to instruct the source computing device to resume transmitting messages to the target computing device.

Example 16 includes the subject matter of Example 15, and further including means for determining, subsequent to having dropped the received message, whether the disabled event counter value is less than an affected source threshold value; and circuitry for transmitting, in response to a determination that the disabled event counter value is less than the affected source threshold value, the source disable response message to the source computing device.

Example 17 includes the subject matter of any of Examples 15 and 16, and wherein the affected source threshold comprises one of a predetermined value, a dynamic changing value, or a mathematical function which accommodates scale.

Example 18 includes the subject matter of any of Examples 15-17, and further including circuitry for receiving, subsequent to the identified table entry being disabled and prior to the identified table entry being atomically enabled, another message from the source computing device; and circuitry for dropping the other received message; circuitry for transmitting an indication to the source computing device that indicates the other received message has been dropped.

Example 19 includes the subject matter of any of Examples 15-18, and further including means for determining, subsequent to having dropped the received message, whether the disabled event counter value is greater than or equal to an affected source threshold value; and circuitry for transmitting, in response to a determination that the disabled event counter value is greater than or equal to the affected source threshold value, a global sync flow control message to each of the plurality of source computing devices, wherein the global sync flow control message indicates that the target computing device is in global sync flow control recovery.

Example 20 includes the subject matter of any of Examples 15-19, and further including means for determining whether the global sync flow control recovery has completed; means for atomically enabling, in response to a determination that the global sync flow control recovery has completed, the disabled list table; and circuitry for transmitting a global sync resume transmission message to each of the plurality of source computing devices, wherein the global sync resume transmission message indicates that the global sync flow control recovery has completed.

Example 21 includes the subject matter of any of Examples 15-20, and wherein the means for determining whether the flow control recovery has completed comprises means for determining whether each of a plurality of message receive queues have been emptied and message processing resources associated with the identified table entry have been freed.

1. A target computing device for targeted flow control recovery, the target computing device comprising:
a compute engine; and
a network interface controller (NIC) to:
receive a message from a source computing device of a plurality of source computing devices communicatively coupled to the target computing device;
identify, based on the received message, a table entry of a table managed by the target computing device, wherein the table entry comprises one table entry of a plurality of table entries of the table, and wherein the table entry identifies one or more resources usable to process the received message;
determine whether the identified one or more resources usable to process the received message are sufficient to process the received message;
drop, in response to a determination that the resources allocated to the table entry are insufficient to process the received message, the received message;
disable the identified table entry;
transmit a source disable response message to the source computing device, wherein the source disable response message indicates that the target computing device is in targeted flow control recovery and to instruct the source computing device to stop transmitting messages to the target computing device;
increment, subsequent to the transmission of the source disable response message, a disabled event counter value;
receive, in response to having transmitted the source disable response message, an acknowledgement message from the source computing device;
increment, in response to having received the acknowledgement message, a disabled event acknowledgement counter value;
determine whether sufficient resources of the target computing device are available to resume receiving messages;
compare, in response to a determination that sufficient resources of the target computing device are available to resume receiving messages, the disabled event acknowledgement counter value and the disabled event counter value;
atomically enable, in response to the determination that the disabled event counter value is equal to the disabled event acknowledgement counter value, the identified table entry; and
transmit a targeted resume transmission message to the source computing device to instruct the source computing device to resume transmitting messages to the target computing device.

2. The target computing device of claim 1, wherein the NIC is further to:
determine, subsequent to having dropped the received message, whether the disabled event counter value is less than an affected source threshold value; and
transmit, in response to a determination that the disabled event counter value is greater the affected source threshold value, the source disable response message to the source computing device.

3. The target computing device of claim 2, wherein the affected source threshold comprises one of a predetermined value, a dynamic changing value, or a mathematical function which accommodates scale.

4. The target computing device of claim 1, wherein the NIC is further to:
receive, subsequent to the identified table entry being disabled and prior to the identified table entry being atomically enabled, another message from the source computing device;
drop the other received message; and
transmit an indication to the source computing device that indicates the other received message has been dropped.

5. The target computing device of claim 1, wherein the NIC is further to:
determine, subsequent to having dropped the received message, whether the disabled event counter value is greater than or equal to an affected source threshold value; and
transmit, in response to a determination that the disabled event counter value is greater than or equal to the affected source threshold value, a global sync flow control message to each of the plurality of source computing devices, wherein the global sync flow control message indicates that the target computing device is in global sync flow control recovery.

6. The target computing device of claim 5, wherein the NIC is further to:
determine whether the global sync flow control recovery has completed;
atomically enable, in response to a determination that the global sync flow control recovery has completed, the disabled list table; and
transmit a global sync resume transmission message to each of the plurality of source computing devices, wherein the global sync resume transmission message indicates that the global sync flow control recovery has completed.

7. The target computing device of claim 6, wherein to determine whether the flow control recovery has completed comprises to determine whether each of a plurality of message receive queues have been emptied and message processing resources associated with the identified table entry have been freed.

8. One or more machine-readable storage media comprising a plurality of instructions stored thereon that, in response to being executed, cause a target computing device to:
receive, by a network interface controller (NIC) of the target computing device, a message from a source computing device of a plurality of source computing devices communicatively coupled to the target computing device;
identify, by the NIC and based on the received message, a table entry of a table managed by the target computing device, wherein the table entry comprises one table entry of a plurality of table entries of the table, and wherein the table entry identifies one or more resources usable to process the received message;
determine, by the NIC, whether the identified one or more resources usable to process the received message are sufficient to process the received message;
drop, by the NIC and in response to a determination that the resources allocated to the table entry are insufficient to process the received message, the received message;
disable, by the NIC, the identified table entry;
transmit, by the NIC, a source disable response message to the source computing device, wherein the source disable response message indicates that the target computing device is in targeted flow control recovery and to instruct the source computing device to stop transmitting messages to the target computing device;
increment, by the NIC and subsequent to the transmission of the source disable response message, a disabled event counter value;
receive, by the NIC and in response to having transmitted the source disable response message, an acknowledgement message from the source computing device;
increment, by the NIC and in response to having received the acknowledgement message, a disabled event acknowledgement counter value;
determine, by the NIC, whether sufficient resources of the target computing device are available to resume receiving messages;
compare, by the NIC and in response to a determination that sufficient resources of the target computing device are available to resume receiving messages, the disabled event acknowledgement counter value and the disabled event counter value;
atomically enable, by the NIC and in response to the determination that the disabled event counter value is equal to the disabled event acknowledgement counter value, the identified table entry; and
transmit, by the NIC, a targeted resume transmission message to the source computing device to instruct the source computing device to resume transmitting messages to the target computing device.

9. The one or more machine-readable storage media of claim 8, wherein the plurality of instructions further cause the NIC to:
determine, by the NIC and subsequent to having dropped the received message, whether the disabled event counter value is less than an affected source threshold value; and
transmit, by the NIC and in response to a determination that the disabled event counter value is greater the affected source threshold value, the source disable response message to the source computing device.

10. The one or more machine-readable storage media of claim 9, wherein the affected source threshold comprises one of a predetermined value, a dynamic changing value, or a mathematical function which accommodates scale.

11. The one or more machine-readable storage media of claim 8, wherein the plurality of instructions further cause the NIC to:
receive, by the NIC and subsequent to the identified table entry being disabled and prior to the identified table entry being atomically enabled, another message from the source computing device;
drop, by the NIC, the other received message; and
transmit, by the NIC, an indication to the source computing device that indicates the other received message has been dropped.

12. The one or more machine-readable storage media of claim 8, wherein the plurality of instructions further cause the NIC to:
determine, by the NIC and subsequent to having dropped the received message, whether the disabled event counter value is greater than or equal to an affected source threshold value; and
transmit, by the NIC and in response to a determination that the disabled event counter value is greater than or equal to the affected source threshold value, a global sync flow control message to each of the plurality of source computing devices, wherein the global sync flow control message indicates that the target computing device is in global sync flow control recovery.

13. The one or more machine-readable storage media of claim 12, wherein the plurality of instructions further cause the NIC to:
determine, by the NIC, whether the global sync flow control recovery has completed;
atomically enable, by the NIC and in response to a determination that the global sync flow control recovery has completed, the disabled list table; and
transmit, by the NIC, a global sync resume transmission message to each of the plurality of source computing devices, wherein the global sync resume transmission message indicates that the global sync flow control recovery has completed.

14. The one or more machine-readable storage media of claim 13, wherein to determine whether the flow control recovery has completed comprises to determine whether each of a plurality of message receive queues have been emptied and message processing resources associated with the identified table entry have been freed.

15. A target computing device for targeted flow control recovery, the target computing device comprising:
circuitry for receiving a message from a source computing device of a plurality of source computing devices communicatively coupled to the target computing device;
means for identifying, based on the received message, a table entry of a table managed by the target computing device, wherein the table entry comprises one table entry of a plurality of table entries of the table, and wherein the table entry identifies one or more resources usable to process the received message;
means for determining whether the identified one or more resources usable to process the received message are sufficient to process the received message;
circuitry for dropping, in response to a determination that the resources allocated to the table entry are insufficient to process the received message, the received message;
means for disabling the identified table entry;
means for transmitting a source disable response message to the source computing device, wherein the source disable response message indicates that the target computing device is in targeted flow control recovery and to instruct the source computing device to stop transmitting messages to the target computing device;
means for incrementing, subsequent to the transmission of the source disable response message, a disabled event counter value;
means for receiving, in response to having transmitted the source disable response message, an acknowledgement message from the source computing device;
means for incrementing, in response to having received the acknowledgement message, a disabled event acknowledgement counter value;
means for determining whether sufficient resources of the target computing device are available to resume receiving messages;
means for comparing, in response to a determination that sufficient resources of the target computing device are available to resume receiving messages, the disabled event acknowledgement counter value and the disabled event counter value;
means for atomically enabling, in response to the determination that the disabled event counter value is equal to the disabled event acknowledgement counter value, the identified table entry; and
circuitry for transmitting a targeted resume transmission message to the source computing device to instruct the source computing device to resume transmitting messages to the target computing device.

16. The target computing device of claim 15, further comprising:
means for determining, subsequent to having dropped the received message, whether the disabled event counter value is less than an affected source threshold value; and
circuitry for transmitting, in response to a determination that the disabled event counter value is greater the affected source threshold value, the source disable response message to the source computing device.

17. The target computing device of claim 16, wherein the affected source threshold comprises one of a predetermined value, a dynamic changing value, or a mathematical function which accommodates scale.

18. The target computing device of claim 15, further comprising:
circuitry for receiving, subsequent to the identified table entry being disabled and prior to the identified table entry being atomically enabled, another message from the source computing device;
circuitry for dropping the other received message; and
circuitry for transmitting an indication to the source computing device that indicates the other received message has been dropped.

19. The target computing device of claim 15, further comprising:
means for determining, subsequent to having dropped the received message, whether the disabled event counter value is greater than or equal to an affected source threshold value; and
circuitry for transmitting, in response to a determination that the disabled event counter value is greater than or equal to the affected source threshold value, a global sync flow control message to each of the plurality of source computing devices, wherein the global sync flow control message indicates that the target computing device is in global sync flow control recovery.

20. The target computing device of claim 19, further comprising:
means for determining whether the global sync flow control recovery has completed;
means for atomically enabling, in response to a determination that the global sync flow control recovery has completed, the disabled list table; and
circuitry for transmitting a global sync resume transmission message to each of the plurality of source computing devices, wherein the global sync resume transmission message indicates that the global sync flow control recovery has completed.

21. The target computing device of claim 20, wherein the means for determining whether the flow control recovery has completed comprises means for determining whether each of a plurality of message receive queues have been emptied and message processing resources associated with the identified table entry have been freed.
